(19) United States
(12) Patent Application Publication
(10) Pub. No.: US 2006/0293846 A1
(43) Pub. Date: Dec. 28, 2006

(54) Device and method for displaying information

(75) Inventor: Anette Lippert, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/442,260

(22) Filed: May 30, 2006

Related U.S. Application Data
(63) Continuation of application No. PCT/EP04/12752, filed on Nov. 11, 2004.

(30) Foreign Application Priority Data
Nov. 28, 2003 (DE) 103 55 578.1

(51) Int. Cl. G01C 21/32

(52) U.S. Cl. 701/211; 701/208; 340/995.1

(57) ABSTRACT

In the case of a device for displaying information concerning points-of-interest (POIs) which are marked on a map, an individual identification for the POIs is also contained in the map. By transmitting the individual identification, the information may be extracted from a central databank, can be transmitted to a mobile display device, and may be displayed on the mobile display device.

### CROSS REFERENCE TO RELATED APPLICATIONS

This application claims priority under 35 U.S.C. § 120 to International Patent Application No. PCT/EP2004/012752 filed Nov. 11, 2004, and under 35 U.S.C. § 119 to German Patent Application No. 103 55 578.1 filed Nov. 28, 2003, the entire disclosure of these documents is herein expressly incorporated by reference.

### BACKGROUND AND SUMMARY OF THE INVENTION

The invention relates to a device for displaying information concerning points-of-interest (POIs) marked on a map. Furthermore, the present invention relates to a method of retrieving and displaying information concerning such POIs.

POIs (points of interest) are sights, but also restaurants, post offices, event sites, events, museums, public facilities and the like. A “map” is a printed orientation aid, such as city maps, road maps, etc.

It is known to provide information concerning POIs on the map itself, for example, on the back of the map. In addition to the fact that the handling of such a map is difficult, the information has the disadvantage that, as a rule, it is incomplete or outdated. This reduces the benefit of the use which may lead to the user's reaction of not even noticing the information as a result of these disadvantages.

It is an object of the invention to create a device and a method by which up-to-date and complete information regarding the points of interest is always available to the user.

In the case of a device of the above-mentioned type, the object is achieved by providing a device for displaying information concerning POIs marked on a map, wherein an individual identification for the POIs is also contained in the map, the information being extractable from a central databank by transmitting the identification, transmittable to a mobile display device, and displayable thereon. With respect to the method, the object is achieved by providing a method of retrieving and displaying information concerning POIs, which POIs are marked on a map, wherein an SMS with an identification assigned to the POI as content is transmitted to a central databank. The information is read out of the databank and transmitted to the sender, and the information is displayed in the display of a mobile telephone.

By storing information concerning points of interest in a central databank, this information can be kept up-to-date without any problems. For this purpose, it is only necessary for the databank data to be up-to-date. It is also easy to ensure the date's completeness. All data that is of interest may be stored and transmitted upon request.

Instead of the transmission of all data of a point of interest, only the portion of the data which is of interest may be transmitted. This embodiment of the invention is suitable for large data quantities regarding the point of interest.

For this purpose, an additional number or the like may be fed during input of the identification when an inquiry is made; for example, “0” for all data, “1” for a short version of the data, “2” for interested persons who are in a hurry, “3” for interested persons who are not in a hurry, etc. As an alternative, after the input of the identification, a response code can be returned, for example, by SMS (short message service), which, in the case of an input, leads to the return of a list of selection codes, such as 1=museums, 2=hotels, 3=restaurants, etc. If now one of these codes (for example, “1”) is returned again by SMS to the central databank, the interested person receives information on his display device from the central databank concerning the museums open on this day, which is then displayed on the display device.

Advantageous embodiments of the invention are further described and claimed herein, which make it possible to increase the benefit of the use.

If the identification is arranged in the immediate vicinity of the POI, the identification may be read without any problem and may be transmitted rapidly and without errors to the databank.

If the identification is a number code and/or a letter code, it can simply be selected using the keys of an input medium, which are marked with these numbers/letters. As an alternative, it may also be a bar code which can be recorded by means of a bar code reader.

The input medium may, preferably, be a mobile telephone. This mobile telephone has a display anyhow which is then simply used as the display device. As an alternative, other mobile terminals, such as a personal digital assistant, can also be used.

Particularly advantageously, the information can be stored. This is of interest particularly when the information concerning the POIs is queried before the start of a trip and is used within the framework of planning the trip. The driving route and the driving times may be synchronized with the relevant information of the selected driving destinations. When information, such as the opening times and closing days of a trip destination, is transmitted, the unpleasant experience of “standing in front of a locked door” can be avoided.

It is a particularly significant advantage to store the information in a (vehicle) navigation system. This information can be called up in the navigation system when the respective POI has been reached and can contribute to rapidly and reliably mastering the transition from the use of the vehicle to the destination.

A particularly efficient method of retrieving and displaying information concerning POIs consists of transmitting an SMS (or an MMS) with the respective identification of the POI that is of interest by mobile telephone to the databank. For this purpose, the dial-up number of the databank is dialed and the SMS is transmitted. The databank transmits the information to the mobile telephone, where it is shown on the display. By way of a suitable interface, the information may be transmitted to a memory, such as a vehicle navigation system, and, as required, may be read out therefrom as described above.

Other objects, advantages and novel features of the present invention will become apparent from the following detailed description of the invention when considered in conjunction with the accompanying drawings.

### BRIEF DESCRIPTION OF THE DRAWING FIGURES

FIGS. 1 to 4 illustrate the sequence for a call and the display of additional information concerning POIs which are marked on a street map in accordance with the present invention.

### DETAILED DESCRIPTION OF THE PREFERRED EMBODIMENTS

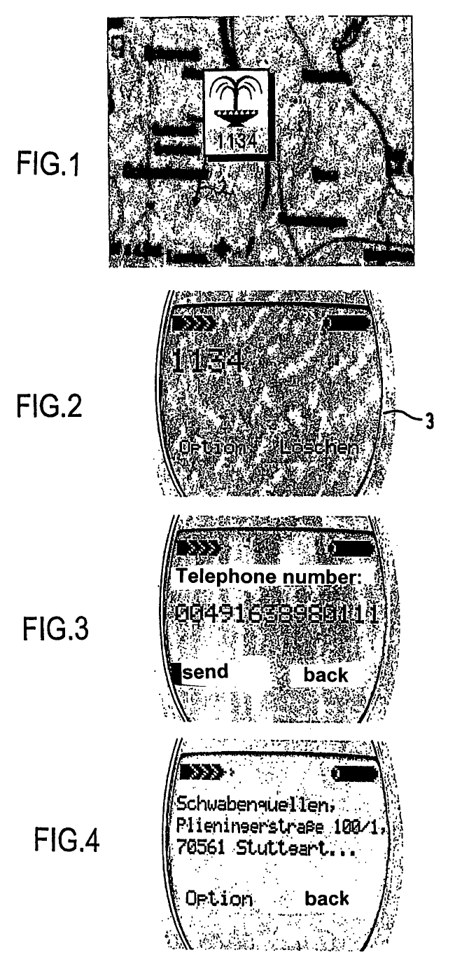

On a printed street map, which is illustrated as a cutout in FIG. 1, the highlighted symbolic representation of a well-known fountain is shown as the POI connected with an arrow 2, which indicates the precise position of the fountain. In addition, a number code (“1134”) is indicated as the individual identification of the fountain.

In order to obtain additional, and naturally up-to-date, information concerning this POI, it is necessary to transmit this identification to a main station by a wireless communication, such as a mobile telephone. This takes place by the input of the individual identification into the mobile telephone. In this case, this identification is first illustrated on the display device of the mobile telephone (FIG. 2). Then, the central databank is dialed. The expediently stored calling number of the databank (FIG. 3) also appears in the display. The databank transmits the pertaining data, which here is the address and the name of the fountain, to the mobile telephone, which data then appears on the display device.

It thereby becomes possible to obtain, as required, up-to-date and comprehensive information concerning points of interest of a map.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for displaying information, the system comprising:
a map on which points-of-interest are marked, an individual identification being provided for the points-of-interest marked on the map;
a central databank containing up-to-date information concerning the points-of-interest marked on the map, the up-to-date information being extractable via the individual identification for each point-of-interest;
a mobile communication unit having a display; and
wherein the individual identification is transmittable from the mobile communication unit for extracting the up-to-date information from the central databank, which extracted up-to-date information is transmittable to the mobile communication unit and displayable on the display of the mobile communication unit.

2. The system according to claim 1, wherein the individual identification is arranged in an immediate vicinity of the point-of-interest marked on the map.

3. The system according to claim 1, wherein the individual identification is a numeric code.

4. The system according to claim 2, wherein the individual identification is a numeric code.

5. The system according to claim 1, wherein the mobile communication unit is a mobile telephone that transmits the individual identification to the central databank.

6. The system according to claim 2, wherein the mobile communication unit is a mobile telephone that transmits the individual identification to the central databank.

7. The system according to claim 3, wherein the mobile communication unit is a mobile telephone that transmits the individual identification to the central databank.

8. The system according to claim 5, wherein a display of the mobile telephone is used as the display.

9. The system according to claim 1, wherein the up-to-date information is stored in a navigation system.

10. A device for displaying information concerning points of interest marked on a map, wherein an individual identification for the points of interest is contained in the map, the information being extractable from a central databank by transmitting the individual identification, the information further being transmittable to a mobile display device for display thereon.

11. The device according to claim 10, wherein the individual identification is arranged in an immediate vicinity of the point-of-interest contained in the map.

12. The device according to claim 11, wherein the individual identification is a numeric code.

13. The device according to claim 10, wherein transmission of the individual identification is performed by a mobile telephone.

14. The device according to claim 13, wherein a display of the mobile telephone is used as the mobile display device.

15. The device according to claim 1, wherein the information is stored.

16. The device according to claim 15, wherein the information is stored in a navigation system.

17. The device according to claim 10, wherein the information is retrievable from a memory.

18. A method of retrieving and displaying information concerning points-of-interest, which points-of-interest are marked on a map, the method comprising the acts of:
transmitting an SMS having an identification assigned to a particular point-of-interest marked on the map as content to a central databank;
reading out of the central databank information about the point-of-interest associated with the identification;
transmitting the information read out of the central databank to a sender of the SMS; and
displaying in a display of a mobile communication unit of the sender the information read out of the central databank about the point-of-interest.
